(19) United States
(12) Patent Application Publication
(10) Pub. No.: US 2009/0145501 A1
(43) Pub. Date: Jun. 11, 2009

(54) PISTON SLIDE VALVE

(75) Inventors: Bernd Kiessling, Hof (DE); Werner Doehla, Gefrees (DE)

Correspondence Address: Pepper Hamilton LLP, 400 Berwyn Park, 899 Cassatt Road, Berwyn, PA, 19312-1183, US

(73) Assignee: RAUSCH & PAUSCH GMBH, Selb (DE)

(21) Appl. No.: 12/328,928

(22) Filed: Dec. 5, 2008

(30) Foreign Application Priority Data
Dec. 5, 2007 (DE) 10 2007 058 620.7

(51) Int. Cl. F15B 13/043; F16K 11/065

(52) U.S. Cl. 137/625.67; 251/129.02; 251/129.08; 137/625.69

(57) ABSTRACT

An electromagnetically actuated piston slide valve (1) with proportional characteristic comprises an axially movable piston (5) for closing radial passage openings (7). So as to change, with a cross-sectional area of the fluid passage openings (7) given by the magnetic drive, a parabolic course of the pressure loss at an increasing flow rate into a largely linear to degressive course, there is provided a pressure-sensing bore (9), which connects the fluid entrance side, at which pressure P₁ is present, with the fluid exit side, at which pressure P₂ is present. In the pressure-sensing bore (9) is axially displaceably disposed a pressure-sensing pin (10) and pushes, when pressure P₁ is greater than pressure P₂, the slide piston (5) into its open position. Thereby the free cross-sectional area of the fluid passage openings (7) increases, and the pressure loss ΔP=P₁−P₂ decreases correspondingly. By a suitable design of the ratio of the magnetic force applied by the magnetic drive and the pressure force applied by the pressure-sensing pin (10) the hydraulic characteristic curve (pressure loss against volume flow) can be adjusted.

### CROSS REFERENCE TO RELATED APPLICATIONS

This application is claims priority to German Application No. 10 2007 058 620.7, filed Dec. 5, 2007, which is incorporated herein by reference in its entirety.

### TECHNOLOGY FIELD

The present invention relates to an electromagnetically actuated piston slide valve, which can be used in control valves for hydraulic media, in particular as a proportional throttle. For example, such a throttle valve can be used as a bypass to a hydraulic shock absorber, in order to set the damping characteristic to be “hard” or “soft.”

### BACKGROUND

Electromagnetically actuated proportional throttles permit a selective change of the cross sectional area of flow independent of auxiliary quantities. The proportional characteristic can be achieved by suitably coordinating and dimensioning the components of the electromagnetic drive. This achieves the result that the stroke of the magnet armature at least over a large range increases approximately proportionally to the drive current. In case of piston slide valves, with which one or a plurality of radial fluid passage openings are closed and opened with the help of an axially movable piston, such proportional characteristic permits a selective changing of the free cross section of the fluid passage openings. The passage openings, for example, can be disposed and dimensioned in such a way, that when the drive current is linearly increased, a change as proportional as possible to it, i.e. likewise linear change, of the free cross section of the fluid passage openings is achieved.

The disadvantage of such proportional throttles is the parabolic course of the pressure loss at increasing flow rate. In case of fluctuations in the flow rate, this can lead to a strong pressure build-up, which can be disturbing in many applications. Instead, a largely linear rise of the pressure loss with an increasing flow rate or even a degressive behavior is desired.

There are known proportional throttle valves formed as slide valves, wherein the attempt is made to achieve a pressure compensation in a largely flow-force compensated fashion. But influencing a characteristic curve by flow forces is only partially realizable. Likewise, such solutions are susceptible with respect to stability and strongly depend on viscosity and temperature.

Therefore, it is these problems that the present invention seeks to solve by providing an electromagnetically actuated piston slide valve, in particular a proportional throttle valve formed as a slide valve, with the help of which there is achieved in a simple fashion over a large range a largely linear rise of the pressure loss with increasing flow rate or even a degressive behavior.

### SUMMARY

The above problems may be solved by an electromagnetically actuated piston slide valve having the features of claim 1. In claims dependent thereon, advantageous embodiments and developments of the invention are specified.

With the valve according to embodiments of the invention for opening and closing the radial fluid passage opening or openings the axially movable piston is spring-preloaded in such a way, that the fluid passage opening in the non actuated state of the valve, i.e., with an exciting coil of the magnetic drive not supplied with current, is either open or closed. Essential for the invention is (at least) one pressure-sensing bore, which, similar to the radial fluid passage opening, connects the fluid entrance side with the fluid exit side. Unlike the fluid passage opening, the pressure-sensing bore preferably is axially disposed, namely in particular coaxially to the axially movable piston. In the pressure-sensing bore there is displaceably disposed a pressure-sensing pin. For minimizing leakage, the pressure-sensing pin is mounted in the pressure-sensing bore preferably with a narrow gap. If necessary, there can be provided one or a plurality of sealing rings. When the valve is in operation, the pressure-sensing pin mounted in such a way in the pressure-sensing bore is pressurized on one side with the pressure present on the fluid entrance side and on the respective opposite side with the pressure present on the fluid exit side. If now on the fluid entrance side there is applied a higher pressure than on the fluid exit side, because of this elevated pressure the pressure-sensing pin will be displaced in such a way that it exerts on the piston, which is disposed on the fluid exit side, a force opposite to the spring force, which pushes the piston in the direction of its open position, in which it clears the opening cross section of the radial fluid passage opening.

This force of the pressure-sensing pin is proportional to the pressure loss occurring at the fluid passage opening. With increasing flow rate and the elevated pressure loss accompanying this, the pressure-sensing pin thus causes a displacement of the piston contrary to the preload spring and thus an enlargement of the free cross section of the fluid passage opening. By a suitable design of the ratio of the magnetic force exerted on the piston by the magnetic drive (by overcoming the preload force of the spring) and the pressure-dependent force exerted on the piston by the pressure-sensing pin, the usually parabolic course of the pressure loss at an increasing flow rate can be changed into an over a large range linear and even degressive course.

The term “pressure-sensing bore” is considered to be a general term in the sense of that the passage between the fluid entrance side and the fluid exit side may be of any kind. Accordingly, the “pressure-sensing pin” can have most different shapes. There can be provided one or a plurality of pressure-sensing bores, in each of which are disposed one or a plurality of pressure-sensing pins, for example a ring-shaped pressure-sensing pin.

The invention can be applied in the same way to a valve having a piston slide, which closes from inside fluid passage openings disposed radially outside, and also to a valve having a piston slide which closes from radially outside fluid passage openings disposed radially inside. The last-mentioned variant is preferred, because it permits a compact formation of the valve. In this case, the end of the piston, with the help of which the radial fluid passage opening is closed, preferably is formed cup-shaped, so that it closes from radially outside the radial fluid passage opening by axially displacing the piston.

According to a preferred embodiment of the invention, the piston is connected via a piston rod with the magnet armature of the magnetic drive, the piston rod being fixed with its end distant from the fluid opening in a central axial bore of the magnet armature at the end of the magnet armature distant from the fluid opening. Thereby, a piston rod with considerable length is obtained, which only at its distant end is connected with the magnet armature, so that it can compensate minor radial fluctuations and tolerances by swiveling and/or bending. This is advantageous for the trouble free operation of the valve.

According to a further preferred embodiment the preload spring, with which the piston is pushed into the normal closed position, is supported against a screw inset. Via the screw depth of the screw inset, the preload force of the spring can be adjusted in a simple fashion.

Additional features and advantages of the invention will be made apparent from the following detailed description of illustrative embodiments that proceeds with reference to the accompanying drawings.

### BRIEF DESCRIPTION OF THE DRAWINGS

In the following detailed description, the invention is described by way of example with reference to the accompanying figures.

FIG. 1 schematically shows the principle of the piston slide valve according to a preferred embodiment of the invention;

FIG. 2 shows the schematic valve from FIG. 1 as a more detailed embodiment;

FIG. 3 shows the hydraulic characteristic curve (pressure drop against flow rate) of the valve from FIG. 1 for different drive currents, but without the pressure sensor according to the invention; and

FIG. 4 shows the hydraulic characteristic curves like in FIG. 3, but with the pressure sensor according to the invention.

### DETAILED DESCRIPTION OF ILLUSTRATIVE EMBODIMENTS

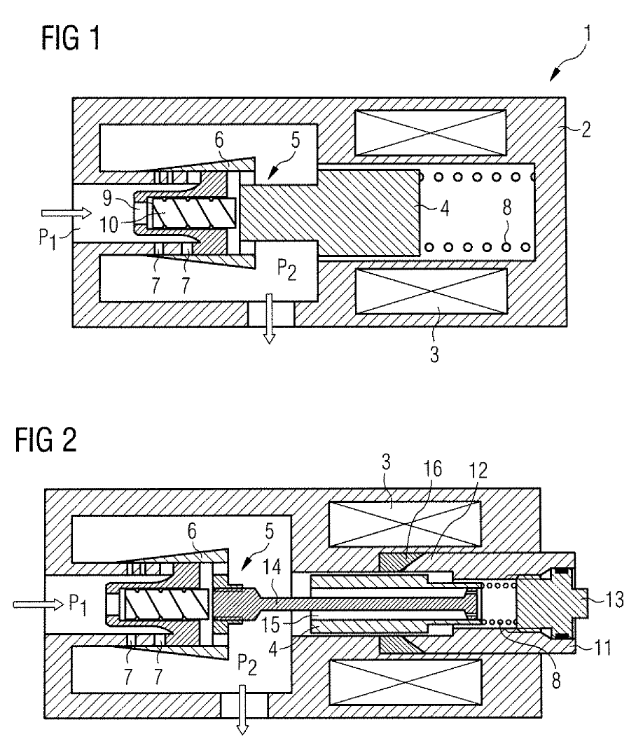

FIG. 1 schematically shows a preferred embodiment of an electromagnetically actuated piston slide valve 1 with integrated pressure-sensing pin 10. Valve 1 comprises a housing 2, in which an exciting coil 3 is accommodated relative to an axially displaceable magnet armature 4. Magnet armature 4 is firmly connected with a piston 5, the free end 6 of which here is formed in a cup-shaped fashion. A displacement of magnet armature 4 in the one or the other axial direction thus at the same time effects a displacement of piston 5 with its cup-shaped free end 6. With the help of the cup-shaped end 6 of piston 5 radial fluid passage openings 7 are closed. A preload spring 8, which acts via the magnet armature 4 on the piston 5, pushes piston 5 in a position, in which radial fluid passage openings 7 are completely closed. Alternatively, preload spring 8 could also be disposed such that it pushes piston 5 into its open position. By supplying exciting coil 3 with current, on magnet armature 4 can be applied a magnetic force, with which piston 5 is axially displaced contrary to the preload force of the spring. Here, varying the free cross-sectional area of fluid passage openings 7 is independent of the pressures P1 or P2 present at the fluid entrance side and the fluid exit side.

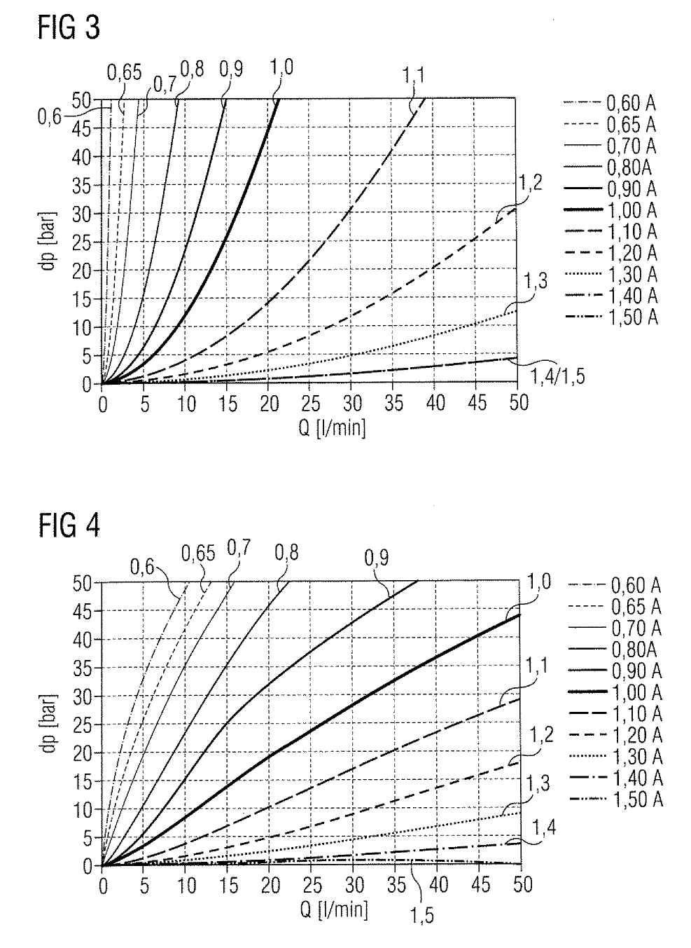

If now piston 5 with the help of the magnetic drive 3, 4 is displaced contrary to the spring force 8 such that the fluid passage opening has a defined opening cross section, normally the pressure loss ΔP=P1−P2 depends on the volume flow Q flowing through the fluid passage opening and takes a respective parabolic course, as it is shown in FIG. 3 for different positions of piston 5, i.e. for different exciting currents.

By there being additionally provided a pressure-sensing bore 9, which connects the fluid entrance side, at which there is present pressure P1, with the fluid exit side, at which there is present pressure P2, and in which pressure-sensing pin 10 is disposed in an axially displaceable fashion, the parabolic course can be changed into a largely linear to degressive course, as it is shown in FIG. 4. This is achieved in that the pressure-sensing pin 10, due to the pressure difference ΔP, is pushed against piston 5 and in this way exerts a pressure force on piston 5, which in the embodiment represented here with normally closed fluid passage openings 7 acts against the preload force of the spring like the magnetic force. (In the case of a valve, which in a state not supplied with current is open, the pressure force of the pressure-sensing pin 10 and the preload force of the spring act in opposite directions). The free cross-sectional area of the fluid passage openings 7 in any case is enlarged by the pressure force of the pressure-sensing pin 10, as a result of which flow rate Q is increased and the pressure difference ΔP again decreases accordingly. By a suitable design of the ratio of the magnetic force generated by the magnetic drive and the pressure-dependent force generated by pressure-sensing pin 10 the hydraulic characteristic curve, as it is shown in FIG. 4, can be adjusted.

The course of the hydraulic characteristic curve can be influenced by changing the preload force of the spring and via a suitable choice of the effective cross-sectional area of pressure-sensing pin 10. The greater the effective cross-sectional area, i.e. in the case of a round pressure-sensing pin 10 the diameter of the pressure-sensing pin, the greater the effect of the pressure force exerted on the piston by the pressure-sensing pin. Correspondingly steeper runs the hydraulic characteristic curve, because flow rate Q increases respectively due to the enlarged free cross-sectional area of the fluid passage openings 7 that comes along with the increased pressure force. If the valve is a normally closed valve, with which the pressure-sensing pin 10, like the magnetic drive, works against the force of the preload spring 8 (FIG. 1), via the adjustment of the preload force of the spring there can be defined a point, at which the valve begins to open due to the pressure difference ΔP, even when there is applied no exciting current or only a low exciting current which solely would not be enough to overcome the preload force of the spring.

FIG. 2 shows another preferred possibility, how the valve schematically shown in FIG. 1 can be advantageously designed. Here the magnetic drive comprises, complementary to exciting coil 3 and magnet armature 4, a magnetic core 11, in which magnet armature 4 is axially displaceable. A magnetically not conductive ring 16 ensures that the magnetic circuit is not closed via magnet armature 4, since then magnet armature 4 would not move when supplied with current. One end of magnetic core 11 has a magnetic cone 12, which may be adjusted with the further components of the valve; in particular magnet armature 4 and preload spring 8, such that altogether an electromagnetic drive with proportional characteristic is given.

In stationary fixed magnetic core 11, the preload spring 8 is axially supported. With the help of a screw inset 13, axially screwed into the magnetic core 11, the preload force of the spring of the preload spring 8 can be exactly adjusted.

According to a further embodiment, piston 5 is formed in a two-part fashion and comprises in addition to the cup-shaped free end 6 a comparatively long and slim piston rod 14, which is screwed into the cup-shaped end 6. With its end distant from fluid passage openings 7 piston rod 14 is fixed in a central axial bore 15 of magnet armature 4, namely again at the end of magnet armature 4 distant from the fluid passage openings 7. By mounting piston 5 at this place, which is far away from the fluid passage openings 7, radial tolerances and fluctuations during operation can be compensated by swiveling and/or bending piston rod 14.

The above-described valve, for example, can be provided as a bypass to a hydraulic damper, in order to set the damping characteristic of the hydraulic damper. With such a bypass having an electromagnetically adjustable throttle valve inserted therein, the total cross sectional area of flow of the hydraulic damper can be varied, so that the damping characteristic can be set to be “hard” and “soft,” as well as to any adjustments in between.

Those skilled in the art will appreciate that numerous changes and modifications may be made to the preferred embodiments of the invention and that such changes and modifications may be made without departing from the spirit of the invention. It is therefore intended that the appended claims cover all such equivalent variations as fall within the true spirit of the invention.

What is claimed is:

1. An electromagnetically actuated piston slide valve (1), comprising:
a valve housing (2) with a fluid entrance side (P₁), a fluid exit side (P₂) and at least one radial fluid passage opening (7) connecting the fluid entrance side with the fluid exit side;
an exciting coil (3) and a piston (5) axially movable with the help of the exciting coil (3), the piston (5) being disposed such that by axially moving the piston (5) the at least one radial fluid passage opening (7) can be opened and closed;
a preload spring (8), with the help of which the piston (5) is preloaded in such a way that the at least one radial fluid passage opening (7), when the exciting coil (3) is in a state not supplied with current, is either open or closed; and
at least one pressure-sensing bore (9) connecting the fluid entrance side (P₁) with the fluid exit side (P₂), in which a pressure-sensing pin (10) is displaceably disposed, during the operation of the valve (1) the pressure-sensing pin (10) at one side being pressurized with the pressure present at the fluid entrance side (P₁) and at the respective opposite side being pressurized with the pressure present at the fluid exit side (P₂) and due to a higher pressure at the fluid entrance side (P₁) being displaced in the pressure-sensing bore (9) in such a way that it exerts a force on the piston (5) acting in an opening direction.

2. The piston slide valve according to claim 1, further comprising an electromagnetic drive with proportional characteristic, the electromagnetic drive comprising:
the exciting coil (3);
a magnetic core (11) complimentary to the exciting coil (3) and stationary fixed in the housing; and
a magnet armature (4) axially displaced in the magnetic core (11) and coupled with the piston (5) and the preload spring (8).

3. The piston slide valve according to claim 2, wherein the magnetic core (4) has a magnetic cone (12).

4. The piston slide valve according to any of claims 1 to 3, further comprising a piston rod (14) connecting the piston (5) with the magnet armature (4), the piston rod (14) being fixed with its end located distant from the at least one fluid passage opening (7) in an axial bore (15) of the magnet armature (4), namely at the end of the magnet armature (4) located distant from the at least one fluid passage opening (7).

5. The piston slide valve according to any of claims 1 to 4, further comprising a screw inset (13), wherein the preload spring (8) is supported against the screw inset (13), and via the screw depth of which the preload force of the preload spring (8) can be adjusted.

6. The piston slide valve according to any of claims 1 to 5, wherein the piston (5) further comprises an end (6), with the help of which the at least one radial fluid passage opening (7) can be closed, wherein the end (6) has a cup-shaped form and closes from radially outside the at least one radial fluid passage opening (7).

7. A hydraulic damper comprising at least one bypass line, in which a piston slide valve (1) according to any of claims 1 to 6 is provided.
